(19) United States
(12) Patent Application Publication
(10) Pub. No.: US 2009/0116833 A1
(43) Pub. Date: May 7, 2009

(54) OPTICAL WAVELENGTH MULTIPLEXED TRANSMISSION APPARATUS

(75) Inventors: Takayuki SHIMIZU, Kawasaki (JP); Hideaki Sugiya, Kawasaki (JP); Taichi Ueki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/241,304

(22) Filed: Sep. 30, 2008

(30) Foreign Application Priority Data
Nov. 5, 2007 (JP) 2007-287919

(51) Int. Cl. H04J 14/00; H04B 17/00; H04B 10/00; H04B 10/08

(52) U.S. Cl. 398/2; 398/26; 398/48

(57) ABSTRACT

Each network device holds as a database parameters relating to the size of a factor of signal degradation of the device, and relays the parameters according to a path through which a signal passes. When each network device receives a relayed parameter, it accumulates the parameter of the device to the received parameter value, and transmits the result to the network device at the next stage. The network device on the terminating side of the path estimates the size of the degradation of the signals in the entire path using the received parameter, thereby determining the reachability as to whether or not a signal can be transmitted through the path.

### CROSS-REFERENCE TO THE RELATED APPLICATIONS

This application is based upon and claims the benefit of priority of the prior Japanese Patent Application No. 2007-287919, filed on Nov. 5, 2007, the entire contents of which are incorporated herein by reference.

### BACKGROUND

1. Field

The present invention relates to an optical wavelength multiplexed transmission apparatus.

2. Description of the Related Arts

In a WDM network configured by an OADM node, an optical cross-connect node, an optical amplifier node, a fiber link, etc., it is requested that a route is automatically determined from the topology of a network and a resource use state on the basis of a path establishment request from a client network device such as an IP router, an ATM switch, etc., and a node through which a path is guided on the basis of the determined route is set, thereby establishing the path.

FIG. 1 shows an example of a path between a WDM network and a client network device.

In FIG. 1, a line is established from an IP router A to an IP router B. A WDM network 14 includes optical add-drop multiplexers 10, 11, and 12, optical cross-connects 13-1 through 13-4. These components are connected through an optical fiber link. Each optical fiber link is provided with an inline amplifier ILA, and amplifies and relays an optical signal. An optical signal from the IP router A is received by the optical add-drop multiplexer 101 and transmitted as a WDM optical signal to the optical cross connect 13-2. The signal from the IP router A is passed from the optical add-drop multiplexer 10 and the optical cross-connects 13-2 and 13-3, add-dropped by the optical add-drop multiplexer 11, and transmitted to the IP router B.

In the process of passing the optical signal through an established path, a transmission line loss reduces an optical power level, the optical amplification in an AMP node accumulates noise, transmission line dispersion degrades a waveform, and the PMD in a transmission line/node generates waveform degradation etc. Therefore, it is necessary to determine whether or not the waveform degradation caused by these factors fall within an allowable range at an optical signal reception terminal.

Conventionally, the determination is manually performed by an operator using a dedicated network design tool as another device. However, for a quick response to a path establish request from a client network device and a shortened service starting time, it is necessary for a device configuration the WDM network to automatically perform the determination on the basis of the configuration/setting information about the device and the fiber link information.

The conventional methods of determining signal receivability are described below.

1) All degradation factors in a path are collected by one management system that calculates the total amount of degradation of the path, and determines the signal transmittability.

2) The amount of degradation up to the immediately preceding node in the path is received from the immediately preceding node, the amount of degradation up to the present node is calculated by adding the received amount to the amount of degradation caused in the present node, the information is transmitted to the subsequent nodes, thereby allowing each node in the path to calculate the amount of degradation up to the node and determine the signal transmittability up to the node. When it is determined by the last node that a signal can be transmitted, it is determined that a signal can be transmitted in the path.

In any case, it is necessary to transmit to the management system or another node the degradation factor relating to the present node or the total amount of degradation up to the present node using a communication path with the management system, a dedicated wavelength for a control signal, a control overhead of a primary signal, etc.

Japanese Laid-open Patent Publication No. 2004-222240 is cited as conventional technology. The patent document discloses a system for monitoring the quality of an optical signal.

Therefore, it is necessary for a device configuring the WDM network to establish a method of automatically determining the path transmittability according to the configuration/setting information about the device and the fiber link information. In this case, when the reachability (whether or not a signal can be transmitted within the allowable degradation range of the signal) of the path is determined, it is necessary to designate a degradation factor to be considered, establish a degradation amount calculation device for each degradation factor, and establish the determination criteria.

### SUMMARY

The present invention aims at providing a optical wavelength multiplexed transmission apparatus capable of automatically determining the transmittability of a path in a wavelength multiplexed optical communication network.

The optical wavelength multiplexed transmission apparatus according to an aspect of an embodiment is used as a node in an optical wavelength multiplexed communication system for transmitting a signal using a path configured by connecting a plurality of nodes from a transmission terminal to a reception terminal. The apparatus includes a database for storing a parameter value of a factor of degrading a transmission signal, a parameter transfer device for accumulating a parameter value of a present node to a parameter value received from a node of a preceding stage, and transferring an accumulated parameter value to a node of a subsequent stage, and a determination device for automatically determining whether or not the parameter value obtained by accumulating the parameter value of the present node to the received parameter value when the present node is a last node of a path, satisfies predetermined criteria by performing a calculation by an evaluation equation indicating an amount of degradation, and determining that a signal can be transmitted through the path when the predetermined criteria are satisfied. With the abovementioned configuration, the availability of the path is automatically determined.

The present invention can provide an optical wavelength multiplexed transmission apparatus capable of automatically determining the transmittability of a path.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 shows an example of a path between a WDM network and a client network device;

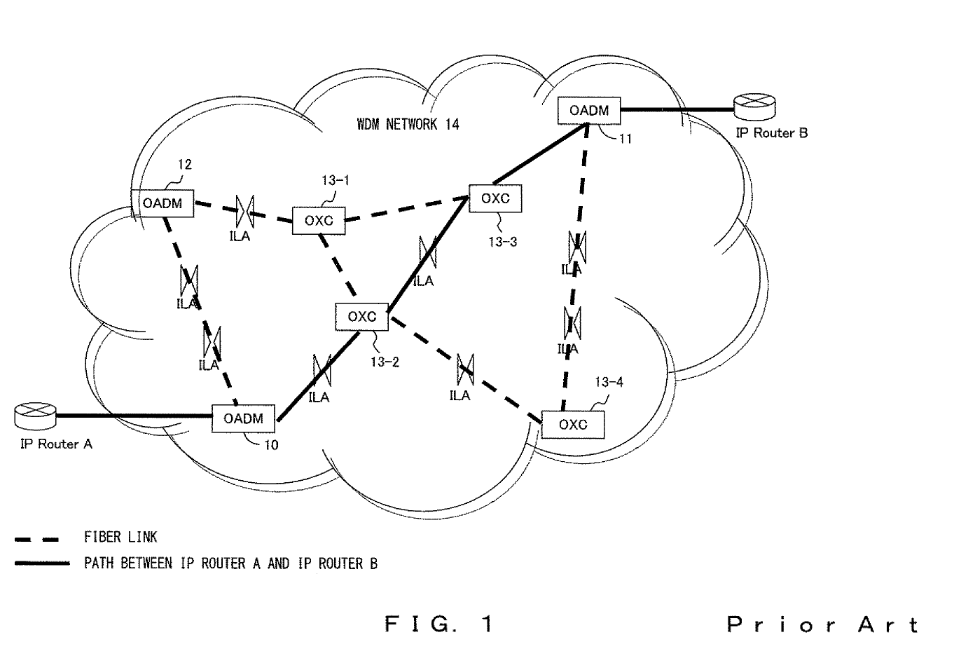

FIG. 2 shows a database and a set value of each node, and transfer data;

FIG. 3 is a flowchart (1) of determining the reachability in a terminating node of a path;

FIG. 4 is a flowchart (2) of determining the reachability in a terminating node of a path;

FIG. 5 is a flowchart (3) of determining the reachability in a terminating node of a path;

FIG. 6 is a flowchart (4) of determining the reachability in a terminating node of a path;

FIG. 7 is an explanatory view (1) showing the relay of a parameter between nodes, and the system of determining the reachability;

FIG. 8 is an explanatory view (2) showing the relay of a parameter between nodes, and the system of determining the reachability;

FIG. 9 is an explanatory view (3) showing the relay of a parameter between nodes, and the system of determining the reachability;

FIG. 10 is an explanatory view (4) showing the relay of a parameter between nodes, and the system of determining the reachability;

FIG. 11 is an explanatory view (5) showing the relay of a parameter between nodes, and the system of determining the reachability;

FIG. 12 is an explanatory view (6) showing the relay of a parameter between nodes, and the system of determining the reachability;

FIG. 13 is an explanatory view (7) showing the relay of a parameter between nodes, and the system of determining the reachability;

FIG. 14 is an explanatory view (8) showing the relay of a parameter between nodes, and the system of determining the reachability;

FIG. 15 shows a block configuration of the node on the transmission terminal side;

FIG. 16 shows a block configuration of the node located in the intermediate portion of a path;

FIG. 17 shows a block configuration of the node on the reception terminal side;

FIGS. 18A and 18B are explanatory views when an embodiment of the present invention is applied to a process of switching a path when a fault occurs; and

FIG. 19 is a flowchart of the process of switching a path when a fault occurs according to an application example shown in FIGS. 18A and 18B.

### DESCRIPTION OF THE PREFERRED EMBODIMENTS

In each node through which a path is set, the amount of degradation in each degradation factor up to the immediately preceding node in the path is received from the immediately preceding node using a communication path with the management system, a dedicated wavelength for a control signal, a control overhead for a primary signal, etc., the amount of degradation up to the present node is calculated by adding the received amount of degradation to the amount of degradation generated in the present node, and the path reachability is determined as OK up to the present node if the calculated amount of degradation falls within a criterion of the determination.

That is, if the calculated amount of degradation falls within a criterion of the determination in a path, it is determined that communications through the path can be established up to the node.

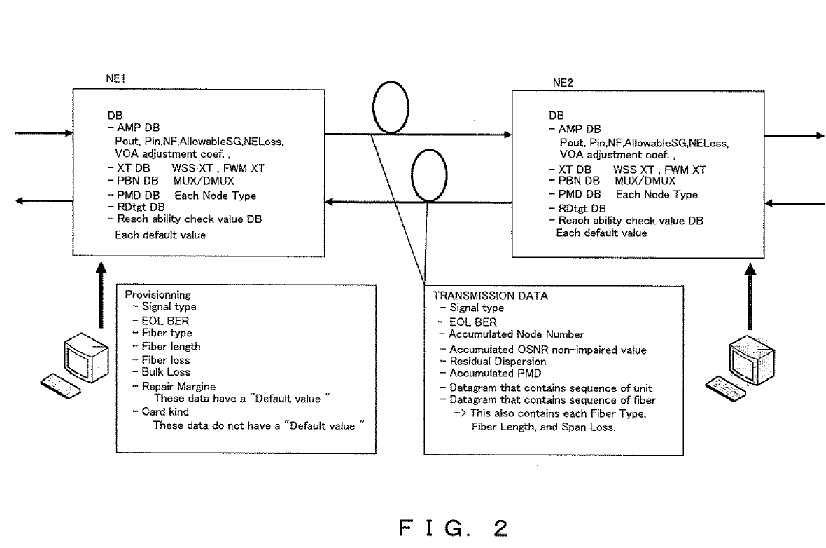

FIG. 2 shows the database and a set value of each node, and transfer data.

Nodes NE1 and NE1 have the same database. In the nodes, an AMP DB stores amplified output Pout, amplified input Pin, a noise figure NF, the allowable range of a system gain (Allowable SG), a node loss (NELoss), and the adjustment coefficient (VOA) of a variable attenuator. As a crosstalk database (Xt DB), a crosstalk of the WSS (wavelength selective switch) and a crosstalk by a combination of four optical waves (FWM XT) are stored. As a pass band database (PEN DB), and a pass band penalty of a multiplexer and a demultiplexer are stored. As a polarization mode dispersion database (PMD DB), the types of nodes are stored. A target residual dispersion database stores a target value of a residual dispersion. A reachability check value database stores as a default a threshold for determination of reachability with the amount of degradation up to the present node.

Provisioning values including a signal type, a required bit error rate (EOL BER), a fiber type, a fiber length, a fiber loss, a connection point loss (bulk loss), an allowable amount of degradation (repair margin (a default is set)), a unit type (card kind (no default)) are set in the database of the node NE.

The data transmitted from node to node include a signal type, a required bit error rate, the number of accumulated nodes, an unadjusted accumulation OSNR value, a residual dispersion, an amount of accumulated and polarization mode dispersion, data of a connected unit, and data of a connected fiber (a fiber type, a fiber length, a span loss, etc.).

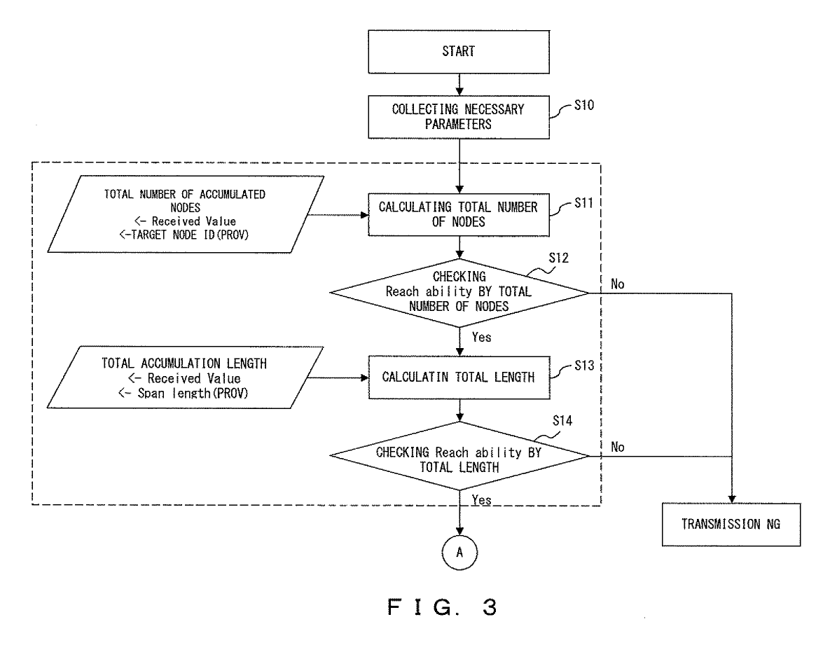

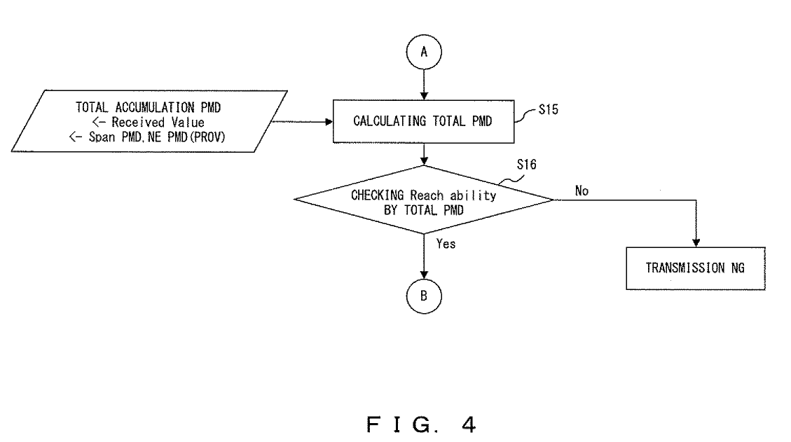

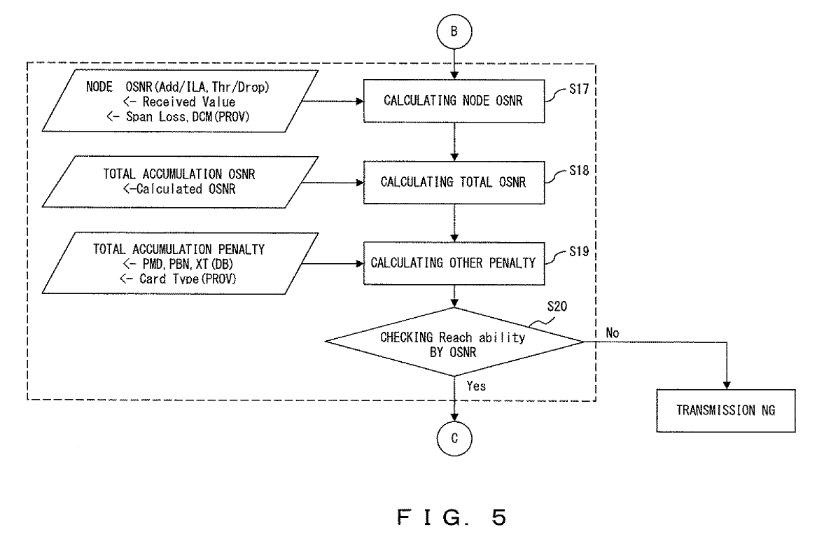

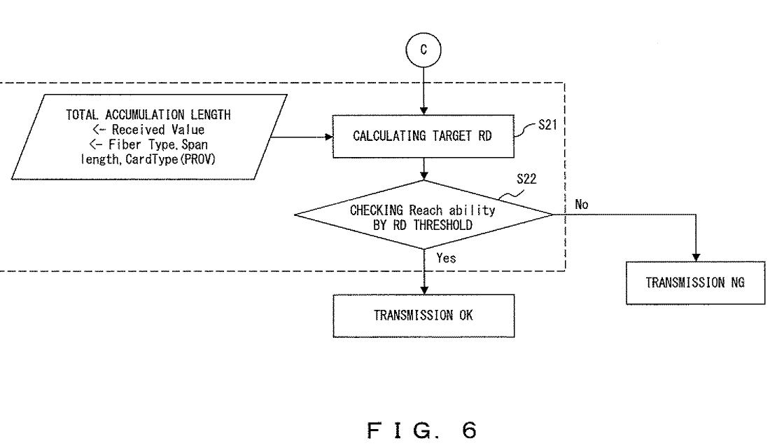

FIGS. 3 through 6 are flowcharts of determining the reachability in a terminating node of a path.

First in step S10, collecting necessary parameters is started. In step S11, the total number of nodes is calculated. It is calculated at the terminating node by accumulating the number of the IDs of the relayed nodes. In step S12, the reachability is checked using the total number of nodes.

If the reachability is NG as a result of the determination in step S12, then it is determined that a signal cannot be transmitted. If the reachability is OK as a result of the determination in step S12, then the total length of fiber is calculated. It is calculated by accumulating at the terminating node the length of each span relayed as a total accumulation value.

In step S14, the reachability is checked from the total length of fiber. If the reachability is NG in step S14, it is determined that a signal cannot be transmitted. If the reachability is OK in step S14, the total PMD (polarization mode dispersion) is calculated.

The total PMD is calculated at the terminating node by sequentially accumulating the values of the PMD of each span and the network device relayed by each node. Each node accumulates the PMD of the present device and the PMD of the span at the preceding stage of the device into the PMD received from the preceding node, and relays, that is, transfers, the value to the next node.

In step S16, the reachability by the entire PMD is checked. If it is determined in step S16 that the reachability is NG, it is determined that a signal cannot be transmitted. If the reachability is OK in step S16, the OSNR of a node is calculated in step S17.

The OSNR of a node is obtained by adding the loss of the span in the preceding stage of the predetermined node and the loss of a dispersion compensation module of the present node to the relayed value. In step S18, the total accumulated OSNR relayed by each node is received at the terminating node, thereby calculating the OSNR of the entire path.

In step S19, a penalty calculation is performed on the basis of other factors from the PMD, a pass band, a crosstalk database, and a unit type. The penalty is also relayed sequentially by each node and accumulated. In step S20, the OSNR checks reachability. If the reachability is NG in step S20, it is determined that a signal cannot be transmitted.

If the reachability is OK in step S20, a target residual dispersion value is calculated in step S21. It is to calculate a residual dispersion at a terminating node by adding the information such as the fiber type, the span length, the unit type, etc. to the total accumulated length relayed through each node. In step S22, the reachability is checked by the threshold of residual dispersion. If the determination of the reachability is NG in step S22, it is determined that a signal cannot be transmitted. If the determination of the reachability is OK, it is described that a signal can be transmitted.

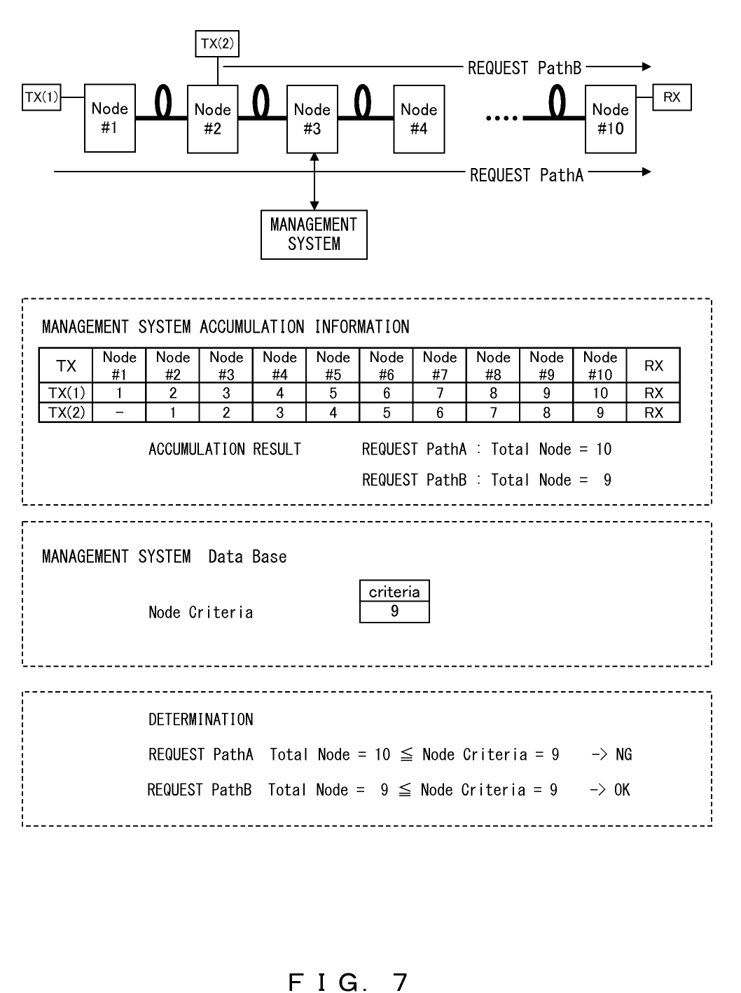

FIGS. 7 through 14 are explanatory views of the relay of a parameter between nodes, and the system of determining the reachability.

The information received from the immediately preceding node, the database and the provisioning value (preset value) in the present node for calculating an amount of degradation, each degradation factor and its calculating/determining method are described below.

The amount of degradation up to the present node is transmitted to the subsequent node using a communication path with the management system, a dedicated wavelength for a control signal, a control overhead in a primary signal, etc. If the amount of degradation of each degradation factor calculated in the last node falls within determination criteria, then it is determined that the path reachability is OK.

The information received from the immediately preceding node, and the database and the provisioning value in the present node for calculating an amount of degradation are stored in each node as the values of its own node.

In each node in the path, the amount of degradation of each degradation factor up to the immediately preceding node in the path is received from the immediately preceding node using the communications of the control sequence of the system, the amount of degradation up to the present node is calculated by adding up the received amount of degradation and the amount of degradation generated in the present node, and it is determined that the path reachability is OK up to the node if the calculated amount of degradation calls within determination criteria. By performing the determination up to the terminating node of the path, the end-to-end path reachability can be determined.

FIG. 7 is an explanatory view of the method of determining the reachability by the number of nodes.

In determining the path reachability, the total number of nodes in the path is one of the determination criteria, and the determination is performed by the following equation.

If total node(i)≦node criteria→OK

where i indicates an index of signal type.

That is, if the total number of nodes in the path is smaller than the node criteria set by a network administrator for each signal type, then the reachability is OK. It is to adopt a path having a smaller number of nodes among the paths formed by the same starting node and the terminating node.

In FIG. 7, assume that paths for which reachability is to be determined are a path A and a path B. The path A is a path from the transmitter TX(1) to the receiver RX. The path B is a path from the transmitter TX(2) to the receiver RX. The determination information about the reachability is managed by the reachability processing unit in the NE.

The management information in the reachability processing unit in the NE stores the number of nodes accumulated by each node while a signal is transmitted from the TX(1) or TX(2) to the RX. Relating to the path A, the number of nodes is 10. Relating to the path B, the number of nodes is 9. When the node criteria is 9, the reachability of the path A is NG because the path A has 10 nodes, but the reachability of the path B is OK because the path B has 9 nodes.

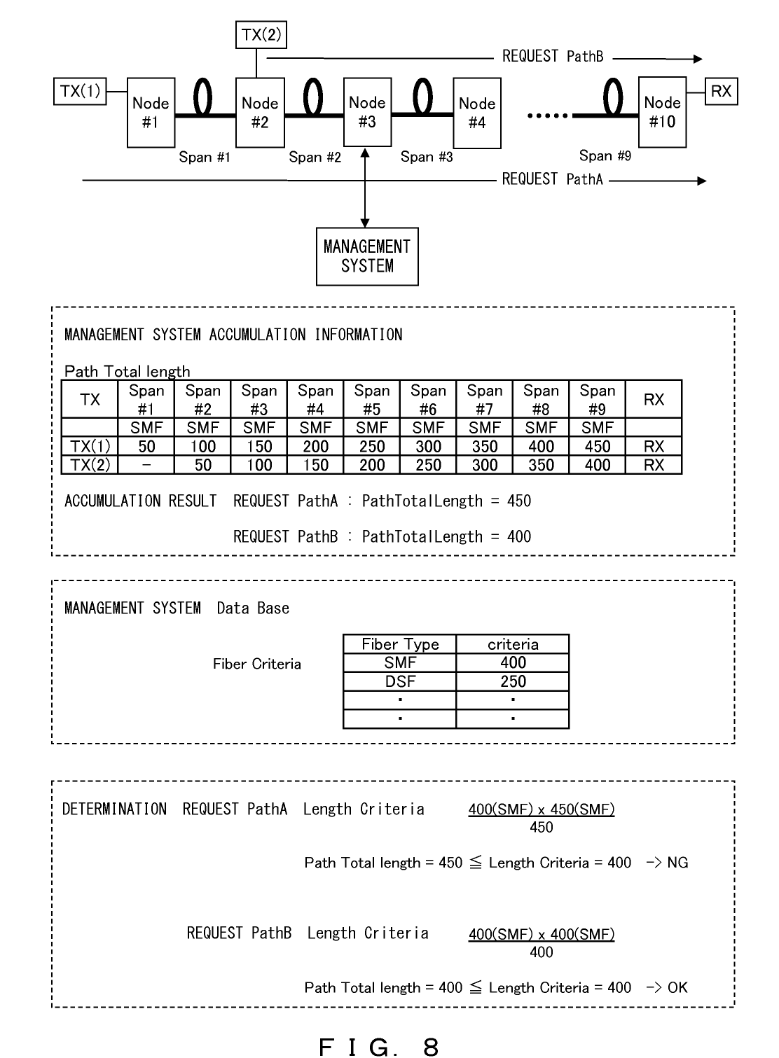

FIG. 8 is an explanatory view of the method of determining the reachability by the total span length.

In determining the path reachability, the total span length in the path between the transmitter and the receiver is one of the determination criteria, a comparison is made with the database for regulating the total transmission distance for each fiber type, and the determination is performed by the following equation when a different fiber exists in the path.

$$LengthCriteria = \frac{{\sum }_{i} FiberCriteria ( i ) \times FiberLength ( i )}{PathTotalLength} \qquad [ Math 1 ]$$

where i indicates an index of fiber kind; FiberLength(i) indicates the total length of fiber of the fiber type i; and PathTotalLengtht indicates the total length of the fiber of the path.

If PathTotalLength≦Length friteria→OK

That is, a preferred transmission distance depends on the fiber type, but the equation above calculates an average preferred transmission distance when various types of fibers are mixed. Therefore, if the average preferred transmission distance is longer than the total length of fiber, it is determined that the reachability is OK.

In FIG. 8, assume that the path A and the path B are the paths for which the reachability is to be determined. The path A is a path from the transmitter TX(1) to the receiver RX, and the path B is a path from the transmitter TX(2) to the receiver RX. The determination information about the reachability is managed by the reachability processing unit in the NE. The management information from the reachability processing unit in the NE stores the fiber length accumulated by each node while a signal is transmitted from the TX(1) or the TX(2) to the RX. Relating to the path A, the fiber length using the SMF is 450. Relating to the path B, the fiber length using the SMF is 400. The length criterion is 400 for the paths A and B. Since the total fiber length of the path A is 450, the reachability is NG. However, since the total fiber length of the path B is 400, the reachability is OK.

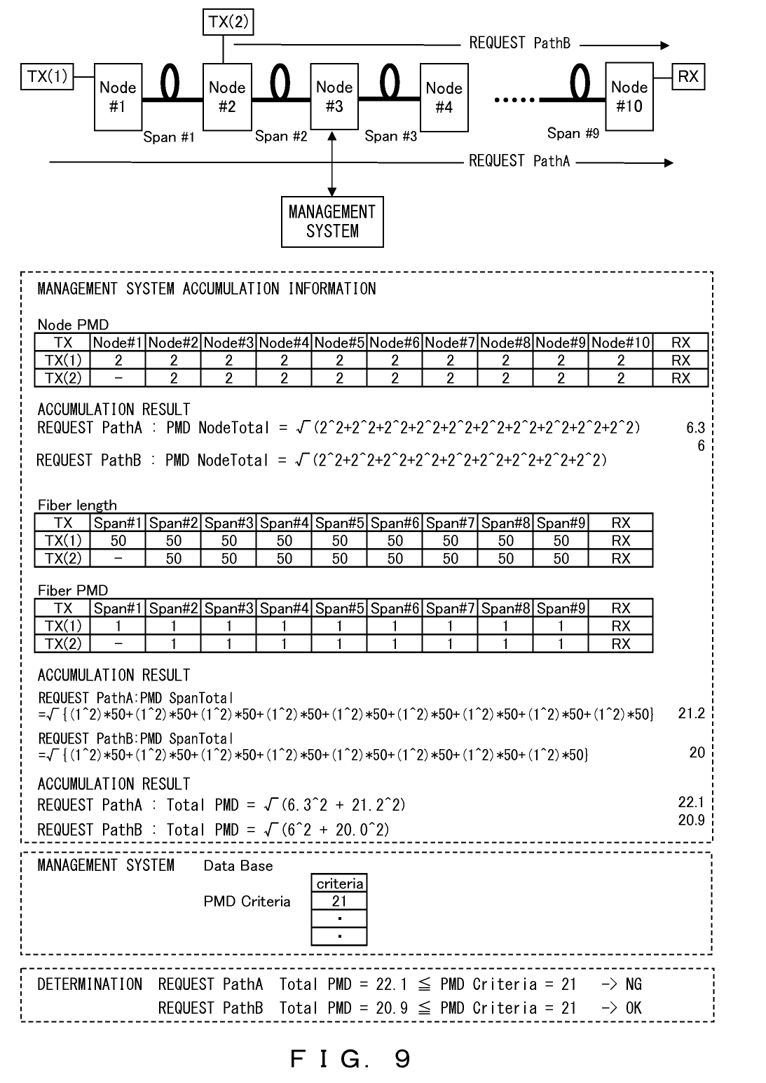

FIG. 9 is an explanatory view of the method of determining the reachability by the PMD.

In determining the path reachability, the total PMD value in the path is one of the determination criteria, and the determination is performed by the following equation.

$$TotalPMD = \sqrt{{PMD}_{NodeTotal}^{2} + {PMD}_{SpanTotal}^{2}} \\ {PMD}_{NodeTotal} = \sqrt{{\sum }_{1}^{m} ( {{NodePMD}_{type ( i )} ( m )}^{2} )} \\ {PMD}_{SpanTotal} = \sqrt{{\sum }_{1}^{n} ( {fiberPMD ( n )}^{2} \times FiberLength ( n ) )} \qquad [ Math 2 ]$$

where i indicates an index of node type; m indicates the number of nodes; and fiberPMD indicates a PMD coefficient (ps/√km)

If totalPMD≦PMD criteria→OK

That is, if the PMD value for the entire path is smaller than a predetermined value, the reachability is OK.

In FIG. 9, assume that the paths A and B are the paths for which the reachability is to be determined. The path A is a path from the transmitter TX(1) to the receiver RX, and the path B is a path from the transmitter TX(2) to the receiver RX. The determination information about the reachability is managed by the reachability processing unit in the NE. The management information from the reachability processing unit in the NE stores the PMD accumulated by each node while a signal is transmitted from the TX(1) or the TX(2) to the RX.

Relating to the path A, the total PMD is 22.1. Relating to the path B, the total PMD is 20.9. The PMD criterion is 21. Since the total PMD for the path A is 22.1, the reachability is NG. However, since the total PMD for the path B is 20.9, the reachability is OK.

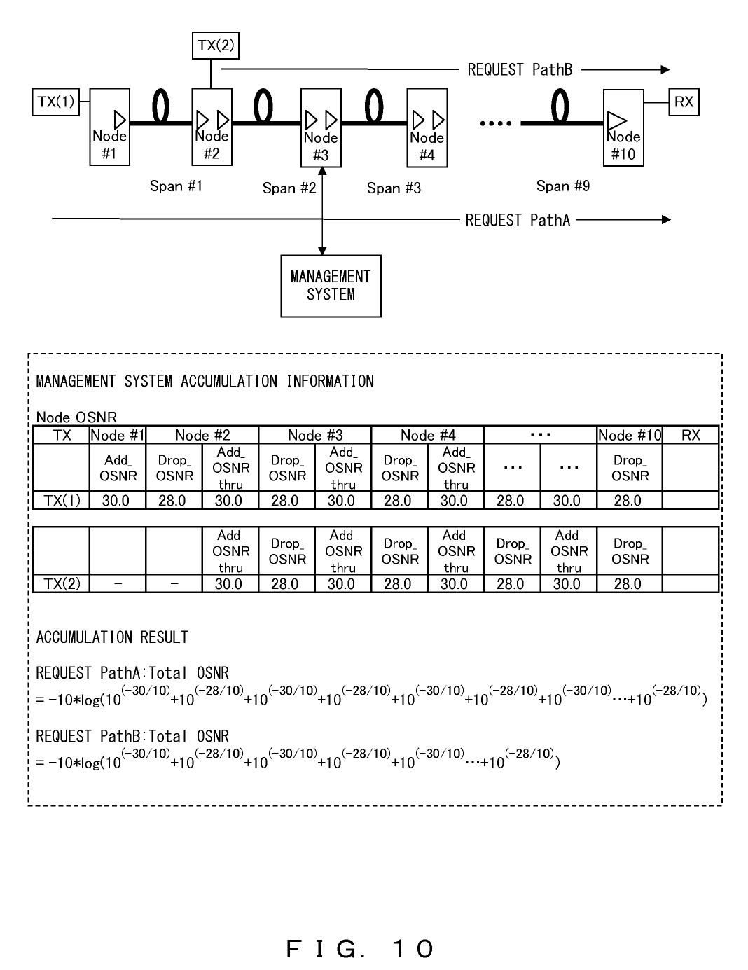

FIG. 10 is an explanatory view of the method of determining the reachability by the OSNR.

In determining the path reachability, the total OSNR value in the path is one of the determination criteria, and the total OSNR value is obtained by the following equation.

$${Total\_OSNR}_{nonimp .} = - 10 \times {log}_{10} ( \begin{matrix}{10}^{\frac{- {Add\_OSNR}_{Add}}{10}} + \\ \underline{{10}^{\frac{- Drop\_OSNR}{10}} + {10}^{\frac{- {Add\_OSNR}_{Thru}}{10}}} … + \\ {10}^{\frac{- Drop\_OSNR}{10}}\end{matrix} ) \qquad [ Math 3 ]$$

In FIG. 10, assume that the paths A and B are the paths for which the reachability is to be determined. The path A is a path from the transmitter TX(1) to the receiver RX, and the path B is a path from the transmitter TX(2) to the receiver RX. The determination information about the reachability is managed by the reachability processing unit in the NE.

The management information from the reachability processing unit in the NE stores the OSNR accumulated by each node while a signal is transmitted from the TX(1) or the TX(2) to the RX. In FIG. 10, the OSNR with Add indicates the output OSNR from a node, and the OSNR with Drop indicates the input OSNR to a node. The total OSNR value is used in determining the reachability after adding a pass band penalty and crosstalk described later.

In calculating the OSNR of each node required in calculating the total OSNR value, the OSNR amount of degradation depending on the equipment input power is owned as a database, and the OSNR value of each node is obtained using the data stored in a database and an equation as described below as an example.

Add_ONSR_{add}=PostAMPin_{add}−NF_{WORST}+57.9

PostAMPin_{add}=−20.4

Drop_OSNR_{□@□™}=PreAMPin−NF_{WORST}+57.9

PreAMPindrop=−Spanloss−TiltPenaltyILAxn

Spanloss=FiberLoss+RepairMargin+BulkLoss×2

Add_OSNRₜₕᵣᵤ=PostAMPinₜₕᵣᵤ−NF_{WORST}+57.9 [Math 4]

where the subscripts add and thru indicate a node on the transmission terminal side in the path or a node positioned at an intermediate portion. NF_{WORST} is the worst value of the noise figure of a node. TiltPenaltyILAxn represents a level difference for each wavelength by a wavelength dependency and a nonlinear effect of a wavelength division multiplexed signal as an amount of degradation. BulkLoss indicates a loss at a connection point between the device and the transmission line. PostAMPin indicates an input level of a post amplifier in a node. PreAMPin indicates an input level of a preamplifier in a node. RepairMargin indicates an allowable margin of an amount of degradation.

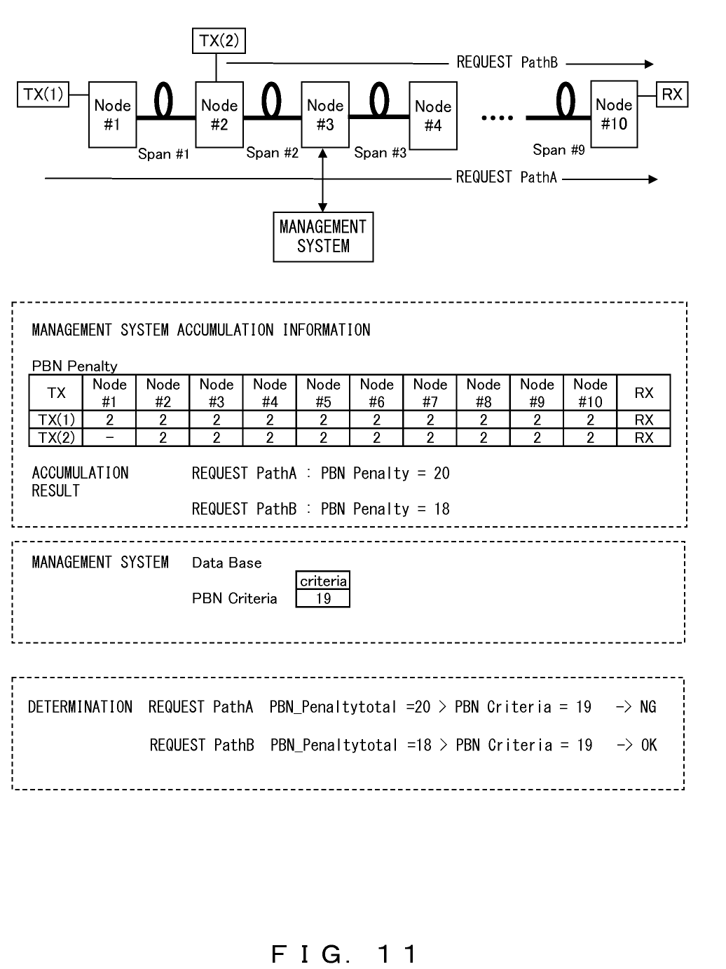

FIG. 11 is an explanatory view of the method of determining the reachability using a band pass penalty.

In determining path reachability, a PBN penalty value in a path is one of the determination criteria, and the determination is performed by the following equation.

The OSNR penalty can be calculated by adding a PBN (pass band penalty). A pass band penalty indicates the amount of degradation in each node because the spectrum of an optical signal is cut away by the margin of the pass band of a filter when a wavelength is selectively retrieved, thereby degrading an optical signal.

PBN_Penaltyₜₒₜₐₗ=Node_PBN₁+Node_PBN₂+ . . . +Node_PBNₙ) [Math 5]

If PBN_Penaltytotal>→NG

X: predetermined value

That is, when the total amount of pass band penalty is equal to or exceed a predetermined value, the reachability is NG.

In FIG. 11, assume that the paths A and B are the paths for which the reachability is to be determined. The path A is a path from the transmitter TX(1) to the receiver RX, and the path B is a path from the transmitter TX(2) to the receiver RX. The determination information about the reachability is managed by the reachability processing unit in the NE. The management information from the reachability processing unit in the NE stores a PBN penalty accumulated by each node while a signal is transmitted from the TX(1) or the TX(2) to the RX. Relating to the path A, the PBN penalty is 20. Relating to the path B, the PBN penalty is 18. Since the criterion value of the PBN penalty of the management system is 19, the reachability of the path A is NG, and the reachability of the path B is OK.

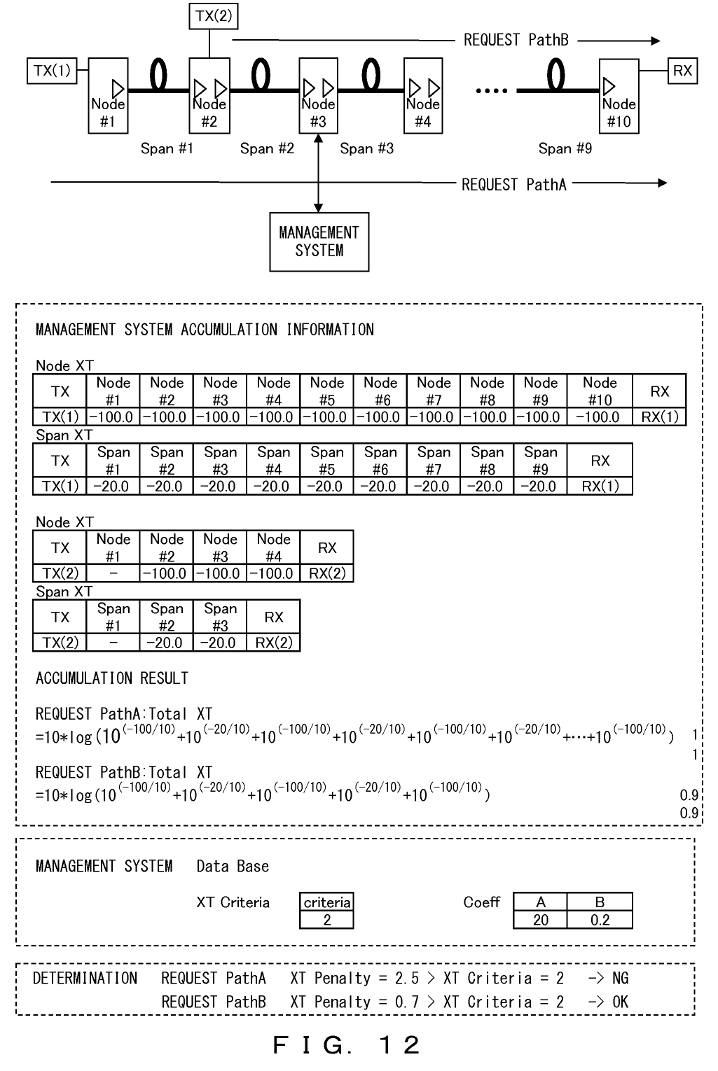

FIG. 12 is an explanatory view of the method of determining the reachability using an amount of crosstalk degradation.

In determining a path reachability, the amount of XT (crosstalk) degradation by a transmission line is one of the determination criteria, the amount of XT generated in each span is stored as a database for each fiber type, the amount of transmission degradation by the XT generated in the transmission line is retrieved from the database or calculated from a determined function as described below as an example.

The OSNR penalty can be calculated by adding the XT.

$${XT\_Penalty}_{total} = Coeff . A \times Exp ( Coeff . B \times XT\_total ) \\ XT\_total = 10 \times {log}_{10} ( \begin{matrix}{10}^{\frac{{CMCXT}_{1}}{10}} + {10}^{\frac{{CMCXT}_{2}}{10}} … + \\ {10}^{\frac{{CMCXT}_{n}}{10}} + {10}^{\frac{{FWMXT}_{1}}{10}} + \\ {10}^{\frac{{FWMXT}_{2}}{10}} … + {10}^{\frac{{FWMXT}_{n}}{10}}\end{matrix} ) \qquad [ Math 6 ]$$

If XT_Penaltytotal>X→NG

X: predetermined value

The reachability is NG when the crosstalk exceeds a criterion value.

Coeff.A and Coeff.B are arbitrary coefficients set by the system administrator.

In FIG. 12, two paths are to be set. The path A is a path from the transmitter TX(1) to the receiver RX(1), and the path B is a path from the transmitter TX(2) to the receiver RX(2).

For each path, the crosstalk in each node and the crosstalk in each span are sequentially accumulated and relayed from one node to another. The reachability processing unit in the NE manages the relayed value of the crosstalk, compares the value with the criterion value of the crosstalk in the database of the reachability processing unit in the NE, thereby determining the reachability.

In the case shown in FIG. 12, the XT penalty of the path A is 2.5, and the XT penalty of the path B is 0.7. On the other hand, since the criteria value is 2, the reachability of the path A is NG, but the reachability of the path B is OK.

In determining the path reachability, the PMD penalty variation in the path is one of the determination criteria, and the determination can be performed by the following equation. The OSNR penalty can be calculated by adding the PMD.

PMD_Penalty=Coeff·A×PMD_tmp̂3+Coeff·B×PMD_tmp̂2+Coeff·C×PMD_tmp̂1+Coeff·D

X: predetermined value

PMD_tmp=Total_PMD×10⁻¹²×Bitate×10⁹ [Math 7]

From Coeff.A to Coeff.D, the relationship between the PMD penalty and the PMD_temp obtained by the equation above is determined for appropriate fitting for an actual measurement value. In the definition equation of PMD_tmp, the coefficient of 10⁻¹² is a conversion coefficient for conversion from “ps” as a unit of Total_PMD to “sec”, and the coefficient of 10¹ is a coefficient for conversion from “Gbit” of Gb/s of Bitrate to “bit”.

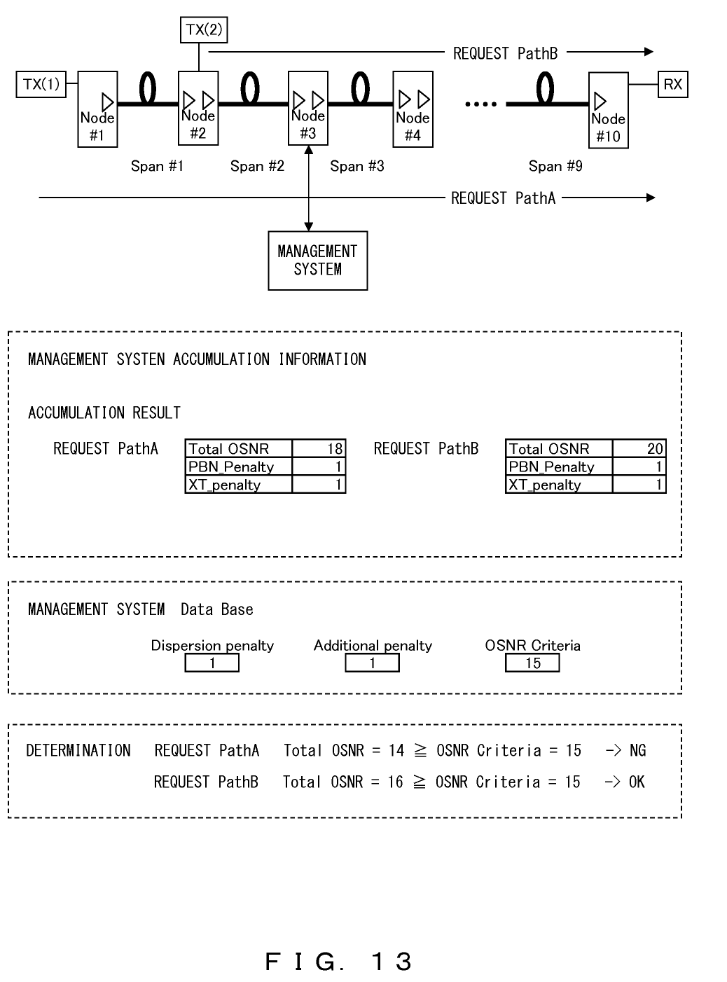

FIG. 13 is an explanatory view of the method of determining the reachability using total OSNR. In determining the path reachability, the total OSNR value in the path is one of the determination criteria, and the determination is performed by the following equation.

$$Total\_OSNR = {Total\_OSNR}_{nonimp .} -- PBN\_Penalty - XT\_Penalty - PMD\_Penalty - Dispersion\_Penalty - Additional\_Penalty \qquad [ Math 8 ]$$

If Total_OSNR≧OSNR Criteria→OK

where Additional_Penalty is a penalty by other factors not contained in each penalty in the equation above.

In FIG. 13, assume that the paths A and B are the paths for which the reachability is to be determined. The path A is a path from the transmitter TX(1) to the receiver RX, and the path B is a path from the transmitter TX(2) to the receiver RX. The determination information about the reachability is managed by the reachability processing unit in the NE. In the management information from the reachability processing unit in the NE, the penalty information about each of the paths A and B is managed. In FIG. 13, the Total_OSNR before an amendment is 18 in the path A, and 20 in the path B. FIG. 13 shows only PBN_Penalty, XT_Penalty, Dispersion_Penalty, and Additional_Penalty each of which is assigned “1”.

A result of subtracting the penalty values from the Total_OSNR before the amendment is the Total_OSNR after the amendment. The resultant value is compared with the OSNR criteria value held in the reachability processing unit in the NE, thereby determining the reachability. Relating to the path A, the Total_OSNR after the amendment is 14. Relating to the path B, the Total_OSNR after the amendment is 16. Since the OSNR criteria value is 15, the reachability of the path A is NG, and the reachability of the path B is OK.

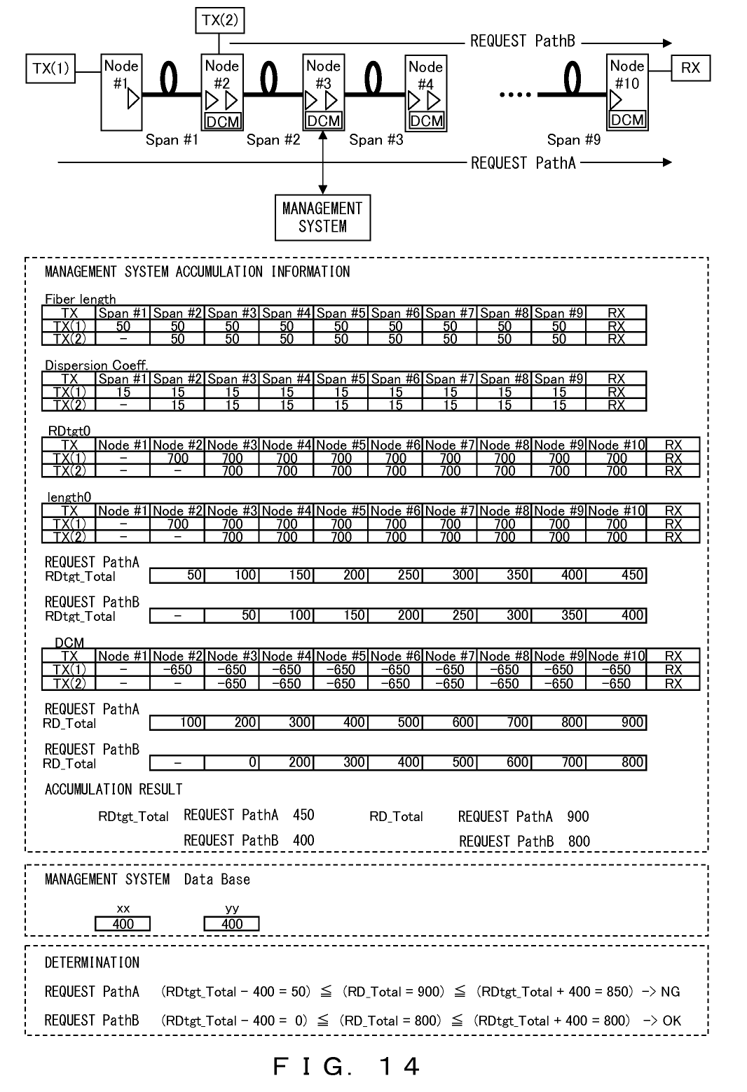

FIG. 14 is an explanatory view of the method of determining the reachability using a residual dispersion value.

In determining the path reachability, the residual dispersion value in the path is one of the determination criteria, and the determination is performed by the following equation.

$$RDtgt = \frac{{RDtgt}_{0}}{{Length}_{0} {D}_{c 0}} \cdot \times FiberLength \times {D}_{c} \\ RDtgt\_Total = {\sum }_{n} RDtgt ( n ) \\ RD\_Total = FiberLength \times {D}_{c} + {Dispersion}_{DCM} \\ RD\_Total = {\sum }_{n} FiberLength \cdot {D}_{c} + {\sum }_{n} {Dispersion}_{DCM} \qquad [ Math 9 ]$$

If RDtgt_Total−xx≦RD_Total≦RDtgt_Total+yy→OK

(xx/yy: value allowed as a difference from RDtgt_Total)

where D_{C} is a dispersion coefficient. RD_{tgt} is a target residual dispersion value, Dispersion_{DCM} is a dispersion value of a dispersion compensation module in the node.

In FIG. 14, assume that the paths A and B are the paths for which the reachability is to be determined. The path A is a path from the transmitter TX(1) to the receiver RX, and the path B is a path from the transmitter TX(2) to the receiver RX. The determination information about the reachability is managed by the reachability processing unit in the NE.

In the management information from the reachability processing unit in the NE, each piece of information used in the calculation by the equation above is managed for each of the paths A and B. In FIG. 14, the RDtgt_Total is 450 and the RD_Total is 900 of the path A. The RDtgt_Total is 400 and the RD_Total is 800 of the path B. If the reachability is determined by the inequality above with xx and yy held in the reachability processing unit in the NE set to 400 (xx=400, yy=400), then the path A is NG, and the path B is OK.

Each of the above-mentioned equation for determining reachability can be arbitrarily combined with each other. In this case, a large amount of information is relayed among nodes.

In determining the path reachability, the following parameters and databases are transmitted among nodes.

signal type

number of accumulated nodes

OSNR value before accumulation amendment

residual dispersion

accumulated PMD

data relating to signal degradation of unit of signal passage portion

data relating to signal degradation of fiber of signal passage portion

The above-mentioned data is not an actual measurement value, but a parameter in accordance with the specification of a device. Using the parameters, a calculation is performed as in the method of determining the reachability as described above, and the degradation of a signal after the passage in the path is estimated. When a signal is actually passed by determining the reachability on the basis of the estimation, a path through which a signal of desired quality can be obtained is selected.

By a node passing in the path autonomically determining the reachability of the path determined in response to a path establish request from a client network device such as an IP router, an ATM switch, etc., a signal transmission test using a measure requiring a manual operation after setting the path can be omitted. Thus, the time and cost required from an occurrence of a path request to the confirmation of reachability can be considerably reduced.

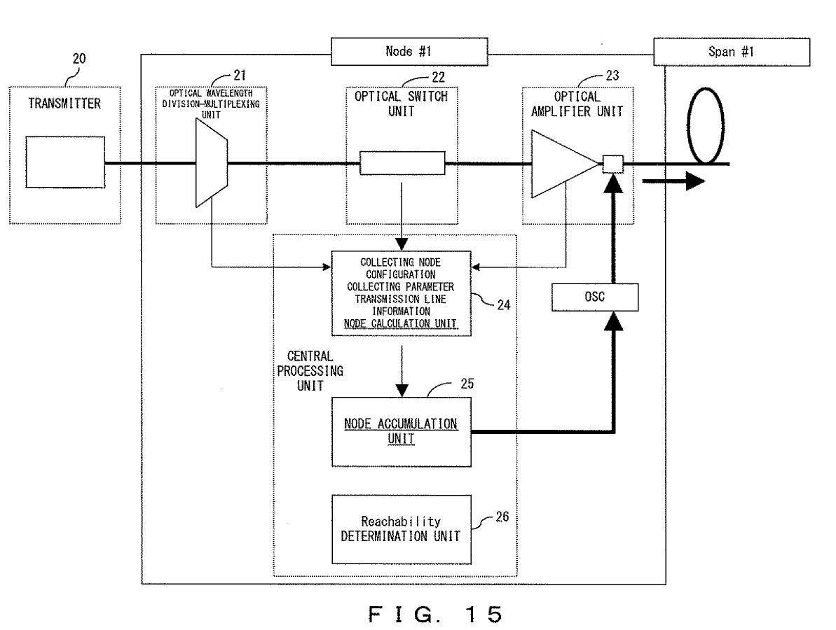

FIG. 15 shows the configuration of a node on the transmission terminal side.

A control signal OSC of an optical wavelength division-multiplexed signal transmitted from a transmitter 20 is demultiplexed. The primary signal is switched by an optical switch unit 22, multiplexed with a control signal OSC newly generated by an optical amplifier unit 23, and transmitted.

The control signal OSC demultiplexed by the optical wavelength division-multiplexing unit 21 is input to a node calculation unit 24. The node calculation unit 24 collects node configuration information from the optical wavelength division-multiplexing unit 21, the optical switch unit 22 and the optical amplifier unit 23. And the node calculation unit 24 collects a parameter of a signal degradation factor, and also collects transmission line information. The information collected by the node calculation unit 24 is input to a node accumulation unit 25.

In the node accumulation unit 25, the parameter of the present node is accumulated to the parameter of the signal degradation factor obtained from the preceding node, and the accumulation information is transmitted to the control signal OSC. A reachability determination unit 26 determines the reachability of the path terminated in the present node.

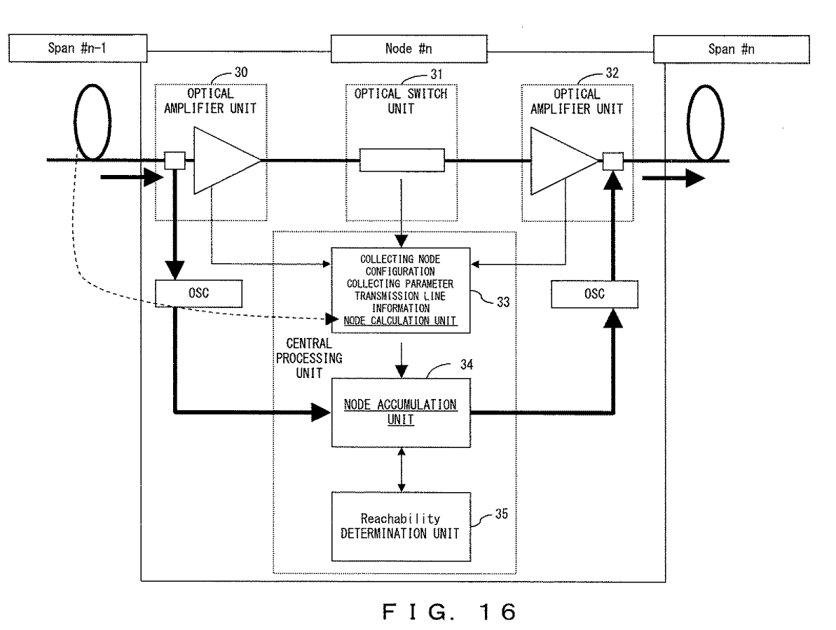

FIG. 16 shows the configuration of a node located at the intermediate portion of the path.

The control signal OSC of the optical wavelength division-multiplexed signal transmitted from the transmission side is demultiplexed in an optical amplifier unit 30. The primary signal is switched in an optical switch unit 31, multiplexed with the control signal OSC newly generated in an optical amplifier unit 32, and transmitted.

The control signal OSC demultiplexed in the optical amplifier unit 30 is input to a node calculation unit 33. The node calculation unit 33 collects node configuration information from the optical amplifier unit 30, the optical switch unit 31, and the optical amplifier unit 32. The node calculation unit 33 collects a parameter of a signal degradation factor, and also collects transmission line information. The information collected by the node calculation unit 33 is input to a node accumulation unit 34.

The node accumulation unit 34 accumulates a parameter of the present node to the parameter of the signal degradation factor obtained from the preceding node, and transmits the accumulated information with the control signal OSC. A reachability determination unit 35 determines the reachability 10 of the path terminated in the present node.

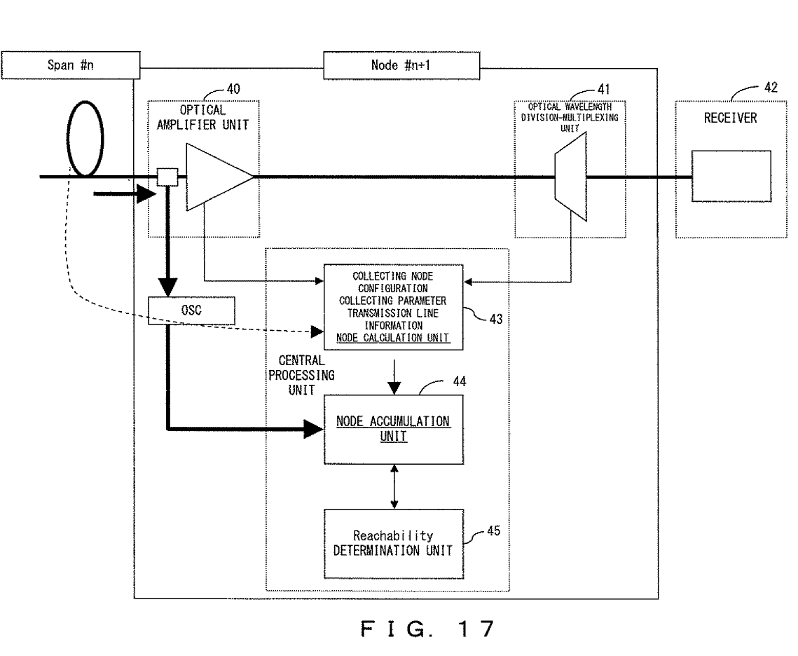

FIG. 17 shows the configuration of a node on the reception terminal side.

The control signal OSC of the optical wavelength division-multiplexed signal transmitted from the transmission side is demultiplexed in an optical amplifier unit 40. The primary signal is transmitted to a receiver 42 through an optical wavelength division-multiplexing unit 41. The control signal OSC demultiplexed by the optical amplifier unit 40 is input to a node calculation unit 43.

The node calculation unit 43 collects node configuration information from the optical amplifier unit 40 and the optical wavelength division-multiplexing unit 41, collects a parameter of a signal degradation factor, and also collects transmission line information. The information collected by the node calculation unit 43 is input to a node accumulation unit 44. The node accumulation unit 44 accumulates the parameter of the present node to the parameter of the signal degradation factor obtained from the preceding node, obtains a parameter value of the signal degradation factor of the entire path, and inputs the result to a reachability determination unit 45. The reachability determination unit 35 determines the reachability of the path terminated in the present node.

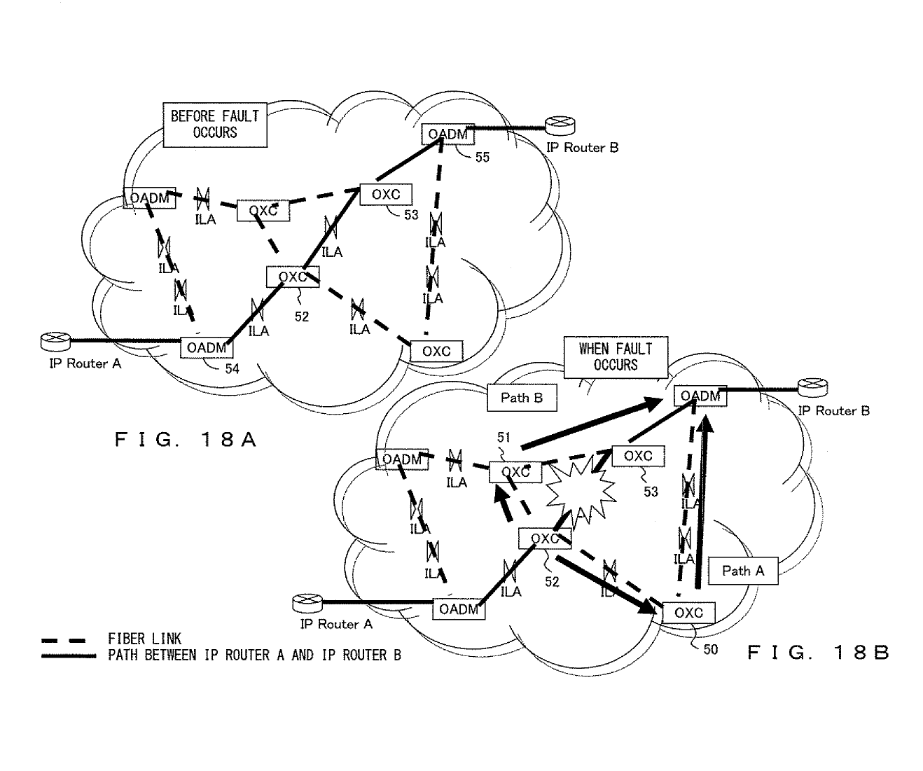

FIGS. 18A and 18B are explanatory views of an embodiment of the present invention applied to the process of switching a path when a fault occurs.

FIG. 18A shows the state before the fault occurs. Assume that a path configured by an add-drop multiplexer 54, cross-connect 52 and 53, and an add-drop multiplexer 55 is established between an IP router A and an IP router B. Next, as shown in FIG. 18B, assume that a fault occurs between the cross-connect 52 and 53, and the path cannot correctly function.

In this case, the method of bypassing the faulty portion and establishing a path between the IP router A and the IP router B can be performed by two paths, that is, the path A through cross-connect 50 an the path B through cross-connect 51. In this case, either of the two paths can be adopted in the above-mentioned embodiment by determining the reachability of the path, that is, whichever is reachable. When both of the paths are reachable, a path having a higher determination value is to be selected.

Since a path can be selected automatically by cross-connect, and the reachability can also be automatically determined by a node, a new path can be quickly established without a network administrator manually switching a path.

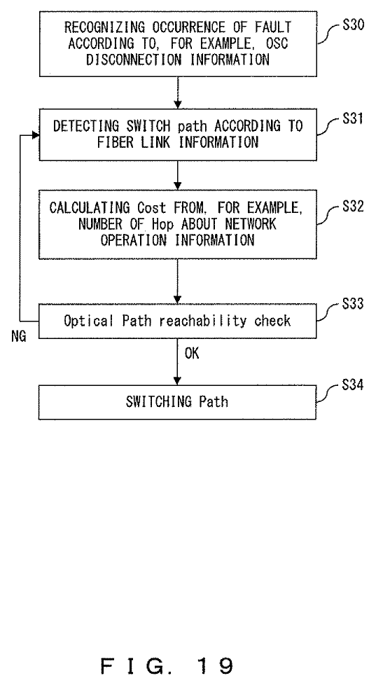

FIG. 19 is a flowchart of the process of switching a path when a fault occurs according to an application example shown in FIGS. 18A and 18B.

In step S30, for example, according to the disconnection information about an OSC signal, an occurrence of a fault is recognized. In step S31, a switched path is detected according to the fiber link information. For example, the paths A and B shown in FIGS. 18A and 18B are detected. Next, the cost of each path is calculated. For example, when the number of HOP is regarded as a cost, the cost is calculated from the number of HOP of the network operation information.

Next, in step S33, the reachability is checked for a lower cost path. If it is OK, a path is switched (step S34). If it is NG, control is returned to step S31, the remaining paths are detected, and lower cost paths are checked for reachability. This process is continued until a path can be successfully switched.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention(s) has(have) been described in detail, it should be understood that the various changes, substitutions, and alterations could be made hereto without departing from the spirit and scope of the invention.

What is claimed is:

1. An optical wavelength multiplexed transmission apparatus used as a node in an optical wavelength multiplexed communication system for transmitting a signal using a path configured by connecting a plurality of nodes from a transmission terminal to a reception terminal, comprising:
a database storing a parameter value of a factor of degrading a transmission signal for a present node;
a parameter transfer device accumulating a parameter value of a present node to a parameter value received from a node of a preceding stage, and transferring an accumulated parameter value to a node of a subsequent stage; and
a determination device automatically determining whether or not the parameter value obtained by accumulating the parameter value of the present node to the received parameter value when the present node is a last node of a path satisfies predetermined criteria by performing a calculation by an evaluation equation indicating an amount of degradation, and determining that a signal can be transmitted through the path when the predetermined criteria are satisfied, wherein
availability of the path is automatically determined.

2. The apparatus according to claim 1, wherein
the parameter value is a number of nodes included in a path, and the criteria refer to the number of nodes less than a predetermined value.

3. The apparatus according to claim 1, wherein
when the parameter value is a total fiber length of the path and the criteria refer to the fiber length of an i-th span of 1 (i), and a preferred transmission distance of a fiber of a type used in the i-th span of f (i), a following expression holds,
(total fiber length)≦(Σᵢ(f(i)×1(i))/(total fiber length).

4. The apparatus according to claim 1, wherein
the parameter value is a polarization mode dispersion value, and the criteria refer to an accumulation value of the polarization mode dispersion value over an entire path equal to or lower than a predetermined value.

5. The apparatus according to claim 1, wherein
the parameter value is an amount of degradation of a signal when an optical signal is branched and inserted in each node, and the criteria refer to the amount of degradation over an entire path equal to or lower than a predetermined value.

6. The apparatus according to claim 1, wherein
the parameter value is an amount of degradation of an OSNR (optical signal to noise ratio) by crosstalk generated when a signal is switched in each node, and the criteria refer to the amount of degradation over an entire path equal to or lower than a predetermined value.

7. The apparatus according to claim 1, wherein
the parameter value is a residual dispersion value in each node, and the criteria refer to a total value of the residual dispersion value over an entire path falling within a predetermined range.

8. The apparatus according to claim 1, wherein
the parameter value is an OSNR (optical signal to noise ratio) value in each node, and the criteria refer to the OSNR over the entire path equal to or larger than a predetermined value.

9. The apparatus according to claim 1, wherein
the parameter value is an OSNR (optical signal to noise ratio) value in each node, and the criteria refer to a value obtained by subtracting from the OSNR over an entire path at least an amount of degradation of a signal when an optical signal over the entire path is branched and inserted, an amount of degradation by crosstalk over the entire path, an amount of degradation bypolarization mode dispersion over the entire path, and an amount of degradation by wavelength dispersion over the entire path, equal to or larger than a predetermined value.

10. The apparatus according to claim 9, wherein
the amount of degradation by the polarization mode dispersion is calculated using an equation obtained by fitting a function of a polarization mode dispersion value over the entire path with an actual measurement value.

11. The apparatus according to claim 8, wherein
the OSNR value is obtained by a following expression when input OSNR of an i-th node is A (i), and output OSNR of the i-th node is D (i),
OSNR=−10×log₁₀(Σᵢ(10̂(−A(i)/10)+10̂(−D(i)/10)))

12. The apparatus according to claim 1, wherein
the parameter value is transferred using a control signal.

13. The apparatus according to claim 1, wherein
the parameter value includes a signal type, a number of nodes, an OSNR (optical signal to noise ratio) value, a residual dispersion value, a polarization mode dispersion value, an amount of degradation of a device unit, an amount of degradation of a transmission line.

14. The apparatus according to claim 1, wherein
the apparatus according to claim 1 selects other candidate paths when a fault occurs in the path, and uses a path satisfying predetermined criteria in the candidate paths as a new path for use in communications.
